(19) United States
(12) Patent Application Publication
(10) Pub. No.: US 2014/0025894 A1
(43) Pub. Date: Jan. 23, 2014

(54) PROCESSOR USING BRANCH INSTRUCTION EXECUTION CACHE AND METHOD OF OPERATING THE SAME

(71) Applicant: Electronics and Telecommunications Research Institute, Daejeon (KR)

(72) Inventor: Young Su KWON, Daejeon (KR)

(21) Appl. No.: 13/945,049

(22) Filed: Jul. 18, 2013

(30) Foreign Application Priority Data
Jul. 18, 2012 (KR) 10-2012-0078199
Jul. 2, 2013 (KR) 10-2013-0077191

(51) Int. Cl. G06F 12/08

(52) U.S. Cl. CPC G06F 12/0875
USPC 711/125

(57) ABSTRACT

A processor using a branch instruction execution cache and a method of operating the same are disclosed. The processor according to an example embodiment of the present invention includes a fetch unit, a branch prediction unit, an instruction queue, a decoding unit and an execution unit operating in a pipeline manner, and includes a branch instruction execution cache that stores address and decode information of a transferred instruction output from the decoding unit, and provides the stored address and at least some of pieces of the decode information to the execution unit in order to overcome branch misprediction when the execution unit determines the branch misprediction. Therefore, with the processor according to an example embodiment of the present invention, overhead of pipeline initialization can be minimized to prevent performance degradation of the processor and reduce power consumption of the processor.

### CLAIM FOR PRIORITY

This application claims priority to Korean Patent Application No. 2012-0078199 filed on Jul. 18, 2012 and No. 2013-0077191 filed on Jul. 2, 2013 in the Korean Intellectual Property Office (KIPO), the entire contents of which are hereby incorporated by reference.

### BACKGROUND

1. Technical Field

Example embodiments of the present invention relate to a processor, and more specifically, to a structure of a processor, a branch instruction execution cache for the processor, and a method of operating the processor, which are capable of reducing overhead generated upon branch misprediction in a high-performance processor core having a deep pipelining structure.

2. Related Art

A processor refers to hardware or IP (Intellectual Property) that executes an algorithm for a specific application area by fetching an instruction stored in a storage device such as a memory or a disk, performing a specific operation on an operand according to an operation encoded in the instruction, and storing a result of the operation again.

The application area of the processor has been widely applied to all system semiconductor fields. For example, the processor is widely used in several application areas, including high-performance media data processing for large-capacity multimedia data such as video data compression and decompression, audio data compression and decompression, audio data transformation and sound effects, a wired/wireless communication modem, a voice codec algorithm, network data processing, a touch screen, a household appliance controller, and a minimal performance microcontroller platform for motor control, as well as an apparatus such as a wireless sensor network or an electronics dust in which stable power supply is difficult or power supply from the outside is difficult.

The processor basically includes a core, a translation lookaside buffer (TLB), and a cache. A task to be performed by the processor is defined by a combination of a plurality of instructions. In other words, instructions are stored in a memory and sequentially input to the processor, and the processor performs a specific operation every clock cycle. The TLB has a function of converting a virtual address to a physical address for execution of an operating system-based application, and the cache serves to increase speed of the processor by temporarily storing, in a chip, instructions stored in an external memory.

Recently, a high-performance processor core of 1 GHz or more has a deep pipelining structure. With this pipelining structure, an operation frequency can be maximized and performance (throughput) can be improved. On the other hand, in the pipelining structure, when a branch instruction is executed, a branch target address for branch is determined in a second half of the pipeline, and accordingly, instructions in a first half of the pipeline in a clock cycle when the branch actually occurs should not be executed. Accordingly, pipeline initialization (pipeline clear) occurs. After the pipeline initialization, instructions are fetched from the branch target address of the branch instruction again, and at this time, performance overhead of 10 cycles or more occurs.

The pipeline initialization (pipeline clear) is a phenomenon that is particularly outstanding in a processor core having a deep pipelining structure. Generally, a processor core having a pipelining structure of about five steps does not have a special measure for the pipeline initialization, whereas in a processor core having a deep pipelining structure, a branch predictor is implemented.

When fetching an instruction in the first half of the pipeline, the branch predictor predicts how branch occurs in advance and fetches the instruction from the predicted memory address. A result of the branch prediction is transferred to the second half of the pipeline. When the branch target address is determined in the second half of the pipeline, it is checked whether the branch prediction in the first half of the pipeline is correct. When the branch prediction is correct, an operation of the core is continued without pipeline initialization. On the other hand, when the branch prediction is not correct, that is, when branch misprediction occurs, a pipeline initialization process is performed. In other words, since the pipeline initialization occurs even when the branch predictor is used, there is a need for a scheme for minimizing overhead due to the pipeline initialization when the branch misprediction occurs.

### SUMMARY

Accordingly, example embodiments of the present invention are provided to substantially obviate one or more problems due to limitations and disadvantages of the related art.

Example embodiments of the present invention provide a structure of a processor that enables fast recovery of branch misprediction and is capable of minimizing pipeline initialization overhead for recovery of the branch misprediction, for performance improvement and power consumption reduction of a processor having a pipelining structure.

Example embodiments of the present invention also provide a method of operating a processor that enables fast recovery of branch misprediction and is capable of minimizing pipeline initialization overhead for recovery of the branch misprediction, for performance improvement and power consumption reduction of a processor having a pipelining structure.

Example embodiments of the present invention also provide a structure of a branch instruction execution cache that enables fast recovery of branch misprediction and is capable of minimizing pipeline initialization overhead for recovery of the branch misprediction, which can be applied to a processor having a pipelining structure for performance improvement and power consumption reduction of a processor.

In some example embodiments, a processor includes a fetch unit configured to fetch a current instruction from an instruction cache; a branch prediction unit configured to receive and output the current instruction, perform branch prediction when the current instruction is a branch instruction, and control the fetch unit to output a next instruction from a branch target address of the current instruction or from an address next to an address in which the current instruction is located according to a result of the branch prediction; an instruction queue configured to store the instruction output from the branch prediction unit; a decoding unit configured to decode the instruction transferred from the instruction queue and output an address and decode information of the transferred instruction; an execution unit configured to perform an operation corresponding to the decode information based on the address and the decode information of the instruction output from the decoding unit; and a branch instruction execution cache configured to store the address and the decode information of the instruction output from the decoding unit, and provide at least some of pieces of the stored decode information to the execution unit in order to recover branch misprediction when the execution unit determines the branch misprediction.

Here, the fetch unit, the branch prediction unit, the instruction queue, the decoding unit and the execution unit may operate in a pipeline manner. In this case, when the execution unit determines the branch misprediction and the branch instruction execution cache does not provide at least some of pieces of the decode information to the execution unit, pipeline initialization may be performed.

Here, the fetch unit may fetch the next instruction from the branch target address of the current instruction when the branch prediction unit predicts that branch will occur at the current instruction, and from the address next to the address in which the current instruction is located when the branch prediction unit predicts that the branch will not occur at the current instruction.

Here, the branch instruction execution cache may store decode information of at least some of the instructions after the branch instruction.

Here, the branch instruction execution cache may store decode information of at least some of instructions located after the branch target address of the branch instruction.

Here, the branch instruction execution cache may include: a saving unit configured to receive the address and the decode information of the decoded instruction from the decoding unit of the processor; a memory unit configured to receive and store the address and the decode information of the decoded instruction from the saving unit; and a recovery unit configured to receive a branch misprediction signal from the execution unit and provide the decode information stored in the memory unit to the execution unit.

In this case, the memory unit may include: a tag memory in which at least one tag item identified by at least a part of the address of the decoded instruction has been stored; and an instruction group memory including instruction groups identified in one-to-one correspondence by the tag items, and the instruction group may store decode information for at least one instruction.

In this case, the saving unit may store at least a part of the address of the instruction in the tag item of the tag memory selected based on the address of the instruction output from the decoding unit, and store the decode information of the output instruction in the instruction group of the instruction group memory identified by the selected tag item.

In this case, the recovery unit may receive the branch misprediction signal and the branch target address from the execution unit, read instruction decode information belonging to the instruction group of the instruction group memory identified by the tag item of the tag memory selected with reference to the branch target address, and transfer the instruction decode information to the execution unit.

In other example embodiments, a method of operating a processor includes: a branch prediction step of outputting and analyzing a current instruction fetched from an instruction cache, performing branch prediction when the current instruction is a branch instruction, and outputting a next instruction from a branch target address of the current instruction or from an address next to an address in which the current instruction is located according to a result of the branch prediction; an instruction storing step of storing the instruction output from the branch prediction step in an instruction queue; a decoding step of decoding the instruction transferred from the instruction queue and outputting an address and decode information of the transferred instruction; and an execution step of performing an operation corresponding to the output instruction based on the address and the decode information of the instruction output from the decoding step, and the address and the decode information of the instruction output in the decoding step are stored, and at least some of pieces of the stored decode information of the instruction are provided to the execution step in order to overcome branch misprediction when the branch misprediction is determined in the execution step.

Here, the branch prediction step, the instruction storing step, the decoding step, and the execution step may operate in a pipeline manner. In this case, when branch misprediction is determined in the execution step and the stored address and at least some of pieces of the decode information of the instruction are not provided to the execution step, pipeline initialization may be performed.

In still other example embodiments, a branch instruction execution cache applied to a processor having a pipelining structure includes: a saving unit configured to receive address and decode information of decoded instruction from a decoding unit of the processor; a memory unit configured to receive and store the address and the decode information of the decoded instruction from the saving unit; and a recovery unit configured to receive a branch misprediction signal from an execution unit of the processor and provide the decode information stored in the memory unit to the execution unit.

Here, the memory unit may include: a tag memory in which at least one tag item identified by at least a part of the address of the decoded instruction has been stored; and an instruction group memory including instruction groups identified in one-to-one correspondence by the tag items, and the instruction group may store decode information for at least one instruction.

Here, the saving unit may store at least a part of the address of the instruction in the tag item of the tag memory selected based on the address of the instruction output from the decoding unit, and store the decode information of the output instruction in the instruction group of the instruction group memory identified by the selected tag item.

Here, the recovery unit may receive the branch misprediction signal and the branch target address from the execution unit, read instruction decode information belonging to the instruction group of the instruction group memory identified by the tag item of the tag memory selected with reference to the branch target address, and transfer the instruction decode information to the execution unit.

Here, pipeline initialization of the processor may be performed when the recovery unit does not provide the decode information stored in the memory unit to the execution unit in response to the branch misprediction signal input from the execution unit.

In a conventional processor core having a deep pipelining structure, whenever branch misprediction occurs, pipeline initialization occurs in order to recover the branch misprediction, which causes performance degradation and increase in power consumption.

In the processor according to an example embodiment of the present invention, a frequency of occurrence of the pipeline initialization can be reduced by storing the decode information of instructions using the branch instruction execution cache and immediately providing the instruction decode information stored in the branch instruction execution cache to the execution unit when branch misprediction occurs. Therefore, with the processor structure according to an example embodiment of the present invention, it is possible to prevent degradation of performance of the processor and reduce power consumption of the processor.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a processor according to an example embodiment of the present invention;

FIG. 2 is a block diagram illustrating a branch instruction execution cache according to an example embodiment of the present invention;

FIG. 3 is a block diagram illustrating the branch instruction execution cache according to an example embodiment of the present invention in detail; and

FIG. 4 is a flowchart illustrating a method of operating a processor according to an example embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the attached drawings.

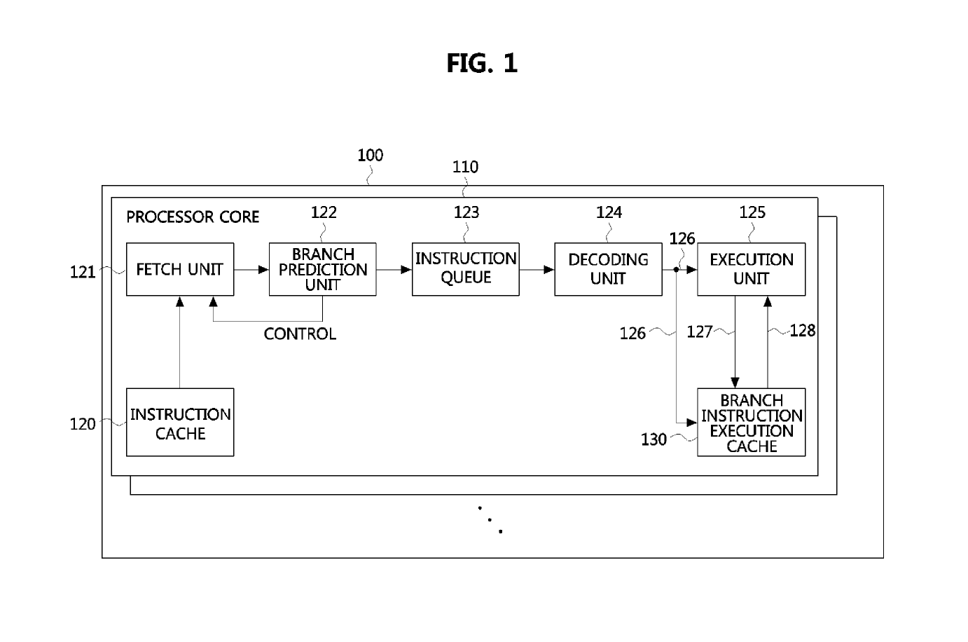

FIG. 1 is a block diagram illustrating a processor according to an example embodiment of the present invention.

Referring to FIG. 1, a processor device 100 according to an example embodiment of the present invention may include a plurality of processor cores 110. Each processor core 110 may include a fetch unit 121, a branch prediction unit 122, an instruction queue 123, a decoding unit 124, and an execution unit 125. In this case, the components (the fetch unit, the branch prediction unit, the instruction queue, the decoding unit and the execution unit) operate in a pipeline manner. The exemplary configuration described above may include only indispensable components of the processor core. A real processor core may include more components in implementation.

Further, in the processor device according to an example embodiment of the present invention, a branch instruction execution cache 130 is interposed between the decoding unit 124 and the execution unit 125.

First, the fetch unit 121 fetches a current instruction from an instruction cache 120 in the processor. The fetch unit 121 may fetch the current instruction from the instruction cache 120 under control of the branch prediction unit 122, which will be described below.

For example, when the current instruction is not a branch instruction, the fetch unit 121 may be configured to sequentially fetch an instruction located in an address next to an address in which the current instruction is located.

Further, when the current instruction is a branch instruction, the fetch unit 121 may fetch an instruction located in a branch target address corresponding to the branch instruction or may fetch the instruction located in the address next to the address in which the current instruction is located, under control of the branch prediction unit 122 (control based on prediction of the branch prediction unit), which will be described below.

The branch prediction unit 122 is a component which receives the current instruction transferred from the fetch unit 121, outputs the current instruction to the instruction queue 123 that will be described below, performs branch prediction when the current instruction is a branch instruction, and controls the fetch unit 121 according to a result of the branch prediction to output a next instruction from the branch target address of the current instruction or from an address next to the address in which the current instruction is located.

In other words, when the current instruction is a branch instruction, the branch prediction unit 122 performs the branch prediction. In this case, the branch prediction unit 122 typically includes a branch target buffer (BTB) and a branch prediction decision (BP) unit for branch prediction. Using the units, the branch prediction unit 122 predicts whether branch will occur and estimates the branch target address when the branch will occur. The branch prediction unit 122 may has various detailed configurations. Since the detailed configuration of the branch prediction unit is out of the scope of the present invention, a detailed description is omitted.

In this case, the branch prediction unit 122 may not always perform correct branch prediction. This is because execution of instructions previously input to the pipeline prior to the branch instruction must be completely terminated in order to exactly recognize the branch target address.

The results of the branch prediction in the branch prediction unit 122 are classified into “Taken” and “Not-Taken.” “Taken” means estimation that branch will really occur and “Not-Taken” means estimation that the branch will not occur.

When the branch prediction result is “Taken,” the branch prediction unit 122 causes the fetch unit 121 to fetch the next instruction from the branch target address. When the branch prediction result is “Not-Taken,” the branch prediction unit 122 causes the fetch unit 121 to fetch the next instruction while continuously increasing the address. When the current instruction input to the branch prediction unit 122 is not a branch instruction, the fetch unit 121 fetches the next instruction while increasing the address, similar to the case in which the branch prediction result is “Not-Taken.”

The output of the branch prediction unit is an instruction sequence guessed by the branch prediction unit, which is input to the instruction queue 123. The instruction queue 123 is a component for storing a number of instructions in order to simultaneously execute a plurality (e.g., 2 to 4) of instructions for a high-performance core processor. The instruction queue may have various detailed configurations. Since the detailed configuration of the instruction queue is out of the scope of the present invention, a detailed description is omitted.

The decoding unit 124 fetches the instruction from the instruction queue, and decodes a type of operation, an operand position, a condition or the like required by the instruction to generate decode information 126. This decode information 126 is transferred to the execution unit 125. The execution unit 125 actually executes an operation corresponding to the instruction based on the decode information.

The branch instruction execution cache 130 serves to store the decode information 126 transferred from the decoding unit 124 as necessary, and transfer the stored decode information 128 to the execution unit in order to recover branch misprediction 127 when the execution unit 125 determines the branch misprediction 127 and notifies branch instruction execution cache 130 of the branch misprediction 127. In other words, the branch instruction execution cache 130 serves to store addresses and the decode information of decoded instructions from the decoding unit, and to provide at least a part of the decode information of the stored instructions to the execution unit in order to recover the branch misprediction when the execution unit determines the branch misprediction.

In other words, the branch instruction execution cache may store decode information of a group of instructions located in the branch target address that should be executed when branch actually occurs by the branch instruction, and decode information of a group of instructions immediately after the branch instruction that should be executed when the branch does not occur by the branch instruction. For example, in the case of the branch instruction (e.g., a loop operation) that should be executed repeatedly, decode information of respective instruction groups which should be executed when the branch occurs and when the branch does not occur as the execution is repeated is stored in the branch instruction execution cache. In this case, even when branch misprediction occurs, the decode information of the instruction groups previously decoded and stored in the branch instruction execution cache can be immediately provided to the execution unit without pipeline initialization.

The processor according to an example embodiment of the present invention is configured such that the pipeline initialization occurs only when the branch instruction execution cache does not provide at least some of pieces of the previously stored decode information for overcoming the branch misprediction to the execution unit 125 even though the execution unit 125 determines the branch misprediction and then notifies the branch instruction execution cache of the branch misprediction. Therefore, the processor according to an example embodiment of the present invention can minimize the overhead due to the pipeline initialization for recovery of the branch misprediction.

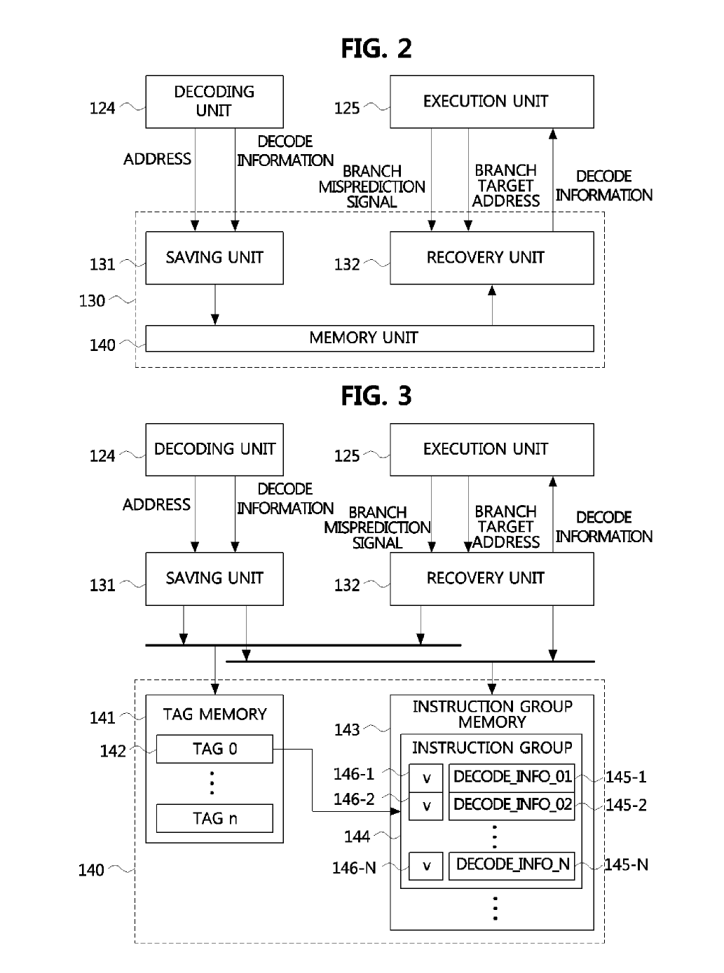

FIG. 2 is a block diagram illustrating a branch instruction execution cache according to an example embodiment of the present invention.

The branch instruction execution cache that will be described below is a component applied to a processor core having a pipelining structure. The processor to which the branch instruction execution cache is applied may typically include a fetch unit, a branch prediction unit, an instruction queue, a decoding unit, and an execution unit, as described above. In the processor having a pipelining structure, the fetch unit, the branch prediction unit, the instruction queue, the decoding unit and the execution unit operate in a pipeline manner. In this case, the branch instruction execution cache 130 according to an example embodiment of the present invention is interposed between the decoding unit 124 and the execution unit 125 and operates.

Referring to FIG. 2, a branch instruction execution cache 130 according to an example embodiment of the present invention includes a saving unit 131, a memory unit 140, and a recovery unit 132.

The saving unit 131 is a component that receives, from the decoding unit 124 of the processor, an address and decode information of an instruction decoded by the decoding unit. In other words, the saving unit 131 serves to receive the address and the decode information of the instruction decoded by the decoding unit, together with the execution unit 125, and store the address and the decode information in the memory unit 140, which will be described below.

The memory unit 140 is a component that receives the address and the instruction decode information of the decoded instruction from the saving unit and stores the address and the instruction decode information. An example embodiment of a configuration of the memory unit will be described below. As described above, the memory unit 140 of the branch instruction execution cache stores the decode information of at least some of instructions after the branch instruction and at least some of instructions located after the branch target address of the branch instruction as the operation of the processor is continued.

The recovery unit 132 serves to receive a branch misprediction signal from the execution unit 125 of the processor, and read the instruction decode information stored in the memory unit and provide the instruction decode information to the execution unit 125 in response to branch misprediction signal.

FIG. 3 is a block diagram illustrating the branch instruction execution cache according to an example embodiment of the present invention in greater detail.

In actual implementation, the branch instruction execution cache that may be applied to the processor of an example embodiment of the present invention may have various forms. FIG. 3 is intended to describe an example of a concrete implementation of the branch instruction execution cache.

Referring to FIG. 3, a memory unit 140 included in the branch instruction execution cache according to an example embodiment of the present invention may include a tag memory 141 and an instruction group memory 143. A saving unit 131 and a recovery unit 132 are components described above with reference to FIG. 2.

First, the tag memory 141 of the branch instruction execution cache may include at least one tag item 142. The tag item is an item corresponding, in one-to-one correspondence, to an instruction group stored in the instruction group memory that will be described below.

Then, the instruction group memory 143 of the branch instruction execution cache includes a plurality of instruction groups, and each instruction group has a plurality of pieces of instruction decode information. In this case, each instruction group maps the tag item 142 of the tag memory 141 in one-to-one correspondence, as described above.

Hereinafter, an operation of the saving unit 131, the recovery unit 132 and the memory unit 140 will be described based on the concrete implementation example of the memory unit 140.

Referring to FIG. 3, the address and the instruction decode information of the decoded instruction as an output of the decoding unit 124 are input to the saving unit 131. The saving unit 131 searches the tag memory 141 for an empty tag item based on the address of the instruction received from the decoding unit 124. When there is no empty tag item, the saving unit 131 selects the tag item (e.g., 142) that has not been used most recently.

The saving unit 131 stores at least a part (e.g., upper bits) of the instruction address in the selected tag item 142. In this case, a reason for storage of the at least a part of the instruction address in the tag item is that the instruction address is used to identify the tag item designating an instruction group in which the decode information of the corresponding instruction is stored. Each tag item maps the instruction group (e.g., 144) in the instruction group memory 143 in one to one correspondence.

One instruction group (e.g., 144) stores a plurality (e.g., 8) of pieces of instruction decode information (e.g., 145-1, . . . , 145-N). The respective instruction decode information (145-1, . . . , 145-N) have valid bits 146-1, . . . , 146-N, which indicate whether the instruction decode information is a result of a valid instruction or not.

When the execution unit 125 determines the branch misprediction, the execution unit 125 notifies the recovery unit 132 of occurrence of the branch misprediction through the branch misprediction signal. The recovery unit 132 searches for a corresponding tag item in the tag memory 141 with reference to the branch target address transferred together with the branch misprediction signal by the execution unit 125. When there is the corresponding tag item, the recovery unit 132 identifies the instruction group mapping the corresponding tag item from the instruction group memory, and provides the instruction decode information of the identified instruction group to the execution unit 125. The processor is controlled so that the pipeline initialization occurs if the recovery unit 132 does not search for the tag item corresponding to the branch target address from the tag memory 141.

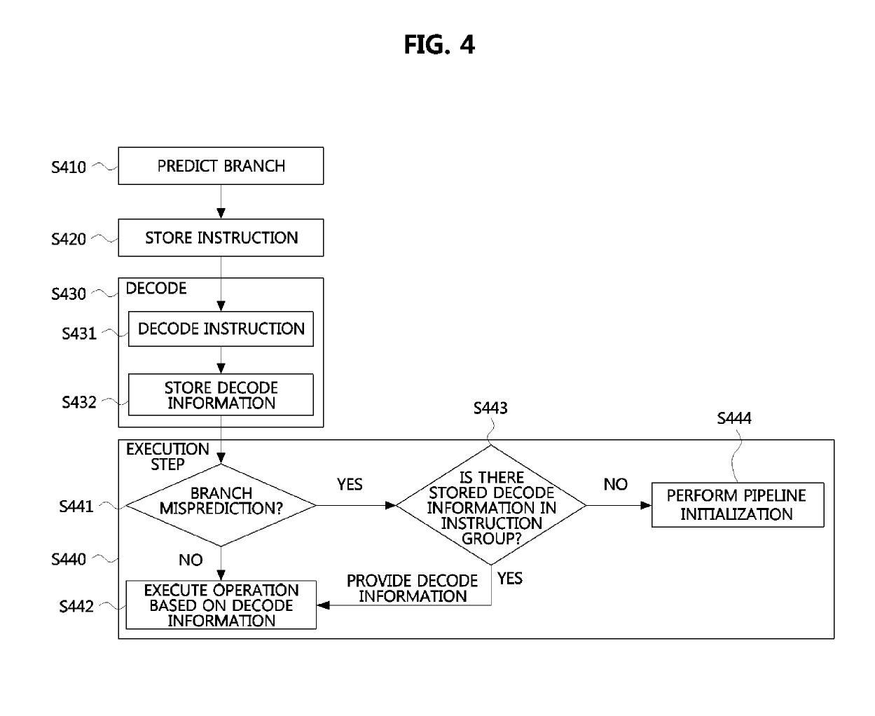

FIG. 4 is a flowchart illustrating a method of operating a processor according to an example embodiment of the present invention.

Referring to FIG. 4, the method of operating a processor according to an example embodiment of the present invention includes a branch prediction step S410, an instruction storing step S420, a decoding step S430, and an execution step S440. The branch prediction step S410, the instruction storing step S420, the decoding step S430, and the execution step S440 operate in a pipeline manner. In other words, the respective steps may operate in parallel.

The branch prediction step S410 is a step in which a current instruction fetched from the instruction cache is output and analyzed, branch prediction is performed when the current instruction is a branch instruction, and a next instruction is output from a branch target address of the current instruction or an address next to an address in which the current instruction is located according to a result of the branch prediction. The branch prediction step S410 may be understood as an operation performed by the fetch unit 121 and the branch prediction unit 122 of the processor according to an example embodiment of the present invention described with reference to FIG. 2.

Then, the instruction storing step S420 is a step of storing, in the instruction queue, the instruction output in the branch prediction step S410, and may be understood as an operation performed by the instruction queue 123 of the processor according to an example embodiment of the present invention described with reference to FIG. 2.

Then, the decoding step S430 is a step of decoding the instruction transferred from the instruction queue and outputting an address and decode information of the transferred instruction, and is a step of decoding the address and the decode information of the transferred instruction (S431), storing the address and the decode information of the decoded instruction in the branch instruction execution cache (S432) and outputting the address and the decode information to the execution step S440. The operation in the decoding step S430 may be understood as an operation performed by the decoding unit 124 and the branch instruction execution cache 130 of the processor according to an example embodiment of the present invention described with reference to FIG. 2.

Finally, in the execution step S440, a determination is made as to whether branch misprediction occurs based on the decode information of the decoded instruction transferred from the decoding step S430 (S441), and when the branch misprediction does not occur, an operation based on the decode information is performed. If it is determined that the branch misprediction occurs, a determination is made as to whether there is decode information of the instructions in the instruction group corresponding to the branch target address stored in the branch instruction execution cache in the decoding step S430 (S443). When there is the decode information, the decode information is fetched from the branch instruction execution cache, and an operation based on the decode information is performed (S442). However, when there is no decode information of the instructions in the instruction group corresponding to the branch target address stored in the branch instruction execution cache, a pipeline initialization process (S444) is performed.

While the example embodiments of the present invention and their advantages have been described in detail, it should be understood that various changes, substitutions and alterations may be made herein without departing from the scope of the invention.

What is claimed is:

1. A processor comprising:
a fetch unit configured to fetch a current instruction from an instruction cache;
a branch prediction unit configured to receive and output the current instruction, perform branch prediction when the current instruction is a branch instruction, and control the fetch unit to output a next instruction from a branch target address of the current instruction or from an address next to an address in which the current instruction is located according to a result of the branch prediction;
an instruction queue configured to store the instruction output from the branch prediction unit;
a decoding unit configured to decode the instruction transferred from the instruction queue and output an address and decode information of the transferred instruction;
an execution unit configured to perform an operation corresponding to the decode information based on the address and the decode information of the instruction output from the decoding unit; and
a branch instruction execution cache configured to store the address and the decode information of the instruction output from the decoding unit, and provide at least some of pieces of the stored decode information to the execution unit in order to recover branch misprediction when the execution unit determines the branch misprediction.

2. The processor according to claim 1, wherein the fetch unit, the branch prediction unit, the instruction queue, the decoding unit and the execution unit operate in a pipeline manner.

3. The processor according to claim 2, wherein: when the execution unit determines the branch misprediction and the branch instruction execution cache does not provide at least some of pieces of the decode information to the execution unit, pipeline initialization is performed.

4. The processor according to claim 1, wherein the fetch unit fetches the next instruction from the branch target address of the current instruction when the branch prediction unit predicts that branch will occur at the current instruction, and from the address next to the address in which the current instruction is located when the branch prediction unit predicts that the branch will not occur at the current instruction.

5. The processor according to claim 1, wherein the branch instruction execution cache stores decode information of at least some of the instructions after the branch instruction.

6. The processor according to claim 1, wherein the branch instruction execution cache stores decode information of at least some of instructions located after the branch target address of the branch instruction.

7. The processor according to claim 1, wherein the branch instruction execution cache includes:
a saving unit configured to receive the address and the decode information of the decoded instruction from the decoding unit of the processor;
a memory unit configured to receive and store the address and the decode information of the decoded instruction from the saving unit; and
a recovery unit configured to receive a branch misprediction signal from the execution unit and provide the decode information stored in the memory unit to the execution unit.

8. The processor according to claim 7, wherein the memory unit includes:
a tag memory in which at least one tag item identified by at least a part of the address of the decoded instruction has been stored; and
an instruction group memory including instruction groups identified in one-to-one correspondence by the tag items, and
the instruction group stores decode information for at least one instruction.

9. The processor according to claim 8, wherein the saving unit stores at least a part of the address of the instruction in the tag item of the tag memory selected based on the address of the instruction output from the decoding unit, and stores the decode information of the output instruction in the instruction group of the instruction group memory identified by the selected tag item.

10. The processor according to claim 8, wherein the recovery unit receives the branch misprediction signal and the branch target address from the execution unit, reads instruction decode information belonging to the instruction group of the instruction group memory identified by the tag item of the tag memory selected with reference to the branch target address, and transfers the instruction decode information to the execution unit.

11. A branch instruction execution cache applied to a processor having a pipelining structure, the branch instruction execution cache comprising:
a saving unit configured to receive address and decode information of decoded instruction from a decoding unit of the processor;
a memory unit configured to receive and store the address and the decode information of the decoded instruction from the saving unit; and
a recovery unit configured to receive a branch misprediction signal from an execution unit of the processor and provide the decode information stored in the memory unit to the execution unit.

12. The branch instruction execution cache according to claim 11, wherein the memory unit includes:
a tag memory in which at least one tag item identified by at least a part of the address of the decoded instruction has been stored; and
an instruction group memory including instruction groups identified in one-to-one correspondence by the tag items, and
the instruction group stores decode information for at least one instruction.

13. The branch instruction execution cache according to claim 12, wherein the saving unit stores at least a part of the address of the instruction in the tag item of the tag memory selected based on the address of the instruction output from the decoding unit, and stores the decode information of the output instruction in the instruction group of the instruction group memory identified by the selected tag item.

14. The branch instruction execution cache according to claim 12, wherein the recovery unit receives the branch misprediction signal and the branch target address from the execution unit, reads instruction decode information belonging to the instruction group of the instruction group memory identified by the tag item of the tag memory selected with reference to the branch target address, and transfers the instruction decode information to the execution unit.

15. The branch instruction execution cache according to claim 12, wherein pipeline initialization of the processor is performed when the recovery unit does not provide the decode information stored in the memory unit to the execution unit in response to the branch misprediction signal input from the execution unit.

16. A method of operating a processor, the method comprising:
a branch prediction step of outputting and analyzing a current instruction fetched from an instruction cache, performing branch prediction when the current instruction is a branch instruction, and outputting a next instruction from a branch target address of the current instruction or from an address next to an address in which the current instruction is located according to a result of the branch prediction;
an instruction storing step of storing the instruction output from the branch prediction step in an instruction queue;
a decoding step of decoding the instruction transferred from the instruction queue and outputting an address and decode information of the transferred instruction; and
an execution step of performing an operation corresponding to the output instruction based on the address and the decode information of the instruction output from the decoding step, and
the address and the decode information of the instruction output in the decoding step are stored, and at least some of pieces of the stored decode information of the instruction are provided to the execution step in order to overcome branch misprediction when the branch misprediction is determined in the execution step.

17. The method according to claim 16, wherein the branch prediction step, the instruction storing step, the decoding step, and the execution step operate in a pipeline manner.

18. The method according to claim 17, wherein: when branch misprediction is determined in the execution step and at least some of pieces of the decode information of the instruction are not provided to the execution step, pipeline initialization is performed.
